(19) United States
(12) Patent Application Publication
(10) Pub. No.: US 2019/0114449 A1
(43) Pub. Date: Apr. 18, 2019

(54) SYSTEMS AND METHODS FOR MAINTAINING RFID TAGS IN A PREDETERMINED STATE

(71) Applicant: SYMBOL TECHNOLOGIES, LLC, Lincolnshire, IL (US)

(72) Inventors: Mark W. Duron, Mastic, NY (US); Thomas E. Wulff, Brookhaven, NY (US); Sean Connolly, Stony Brook, NY (US)

(21) Appl. No.: 15/786,903

(22) Filed: Oct. 18, 2017

(51) Int. Cl. G06K 7/10

(52) U.S. Cl. CPC G06K 7/10019; G06K 7/10237

(57) ABSTRACT

Embodiments of the present invention are directed to the field of RFID readers and more specifically to the selective operation of those readers. In an embodiment, the present invention is a system that alternates the operation of an RFID reader between a continuous wave (CW) only state and a read state depending on an absence or a presence of an object of interest within a read-zone of the RFID reader.

### BACKGROUND

Radio frequency (RF) identification (RFID) systems typically employ RFID readers and RFID tags, whereby RFID readers emit RF energy, interrogating the TFID tags and reading data therefrom. These systems may be used in connection with any number of applications, including asset tracking and locationing. Due to constraints like governmental regulations, the use of RFID may be limited and in some cases RFID readers may be restricted to operating at specific predefined frequencies. This can become problematic as RFID reader signals emitted on the same frequency can collide, causing loss in sensitivity and range. While the problem of signal collision may be avoided to some extent in environments where the RFID devices are allowed to operate at a relatively large number of different frequencies, this becomes more difficult to do as the number of allowable operating frequencies declines and/or the number of RFID readers increases.

The inability to effectively transmit signals via RFID readers may have a negative effect on the effective readability of RFID tags. As skilled artisans will recognize, some RFID tags (such as for example EPC GEN 2 compliant tags) may be switched between a number of sessions. This is typically accomplished by altering the state of an internal flag(s) between state ‘A’ and state ‘B.’ In the example of EPC GEN 2 compliant tags, the default state for an RFID tag before being interrogated by an RFID reader is state ‘A.’ Upon being read, the state is switched to state ‘B,’ indicating to the RFID reader that the tag has already been inventoried and does not need to be read again. This can be advantageous in high-volume settings as inventoried RFID tags in essence stay quiet, diminishing the possibility of transmission collisions. The drawback, however, is that to maintain the tags in state ‘B,’ they have to be subject to an RF field (typically emitted by RFID readers). Consequently, and circling back to the earlier-mentioned problem, in a configuration having a plurality of RFID readers and a limited number of available operating frequencies, the need for constantly active RFID readers increases the likelihood of RF signal collisions, adversely affecting the performance of an RFID system.

Accordingly, there is a need for improved devices, systems, and methods directed towards addressing signal collisions in RFID systems and/or maintaining RFID tags in a desired state.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary system disposed within an exemplary venue in accordance with an embodiment of the present disclosure.

FIG. 2 illustrates a block diagram of a sensing network unit in accordance with an embodiment of the present disclosure.

FIG. 3 illustrates a block communication diagram of some system components in accordance with an embodiment of the present disclosure.

FIG. 4 is a top block diagram of an exemplary venue having a plurality of sensing network units disposed therethroughout.

FIG. 5 is a top block diagram of an exemplary venue having a plurality of sensing network units disposed therethroughout.

FIG. 6 illustrates a flowchart representative of a method in accordance with an embodiment of the present disclosure.

FIG. 7 illustrates a flowchart representative of a method in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an embodiment, the present invention is a system for reading radio frequency (RF) identification (RFID) tags via an interrogation signal. The system includes a plurality of RFID readers spaced apart within a venue, each of the RFID readers being operably switchable between a read state and a continuous wave (CW) only state, each of the RFID readers having a respective read-zone; at least one detector operable to detect a presence of at least one object of interest within the respective read-zone of at least one of the RFID readers; and a controller communicatively connected to the plurality of RFID readers and further to the at least one detector, the controller operable to instruct each of the RFID readers to operate in the read state when the at least one object of interest is detected in the respective read-zone, the controller further operable to instruct each of the RFID readers to operate in the CW-only state when the at least one object of interest is not detected in the respective read-zone.

In another embodiment, the present invention is method of operating a radio frequency (RF) identification (RFID) reader. The method includes: providing, within a venue, an RFID reader having a read-zone, the RFID reader being operably switchable between a read state and a continuous wave (CW) only state; monitoring, via a detector, for a presence of an object of interest within the read-zone of the RFID reader; instructing, by a controller communicatively connected to the RFID reader and further to the detector, the RFID reader to operate in the CW-only state when the object of interest is not detected in the read-zone for a first predetermined amount of time; and instructing, by the controller, the RFID reader to operate in the read state when the object of interest is detected in the read-zone.

In still another embodiment, the present invention is a method of maintaining radio frequency (RF) identification (RFID) tags in a respective state, the RFID tags being switchable between a first state and a second state, and the respective state being one of the first state and the second state. The method includes: providing a plurality of RFID readers spaced apart within a venue, each of the RFID readers being operably switchable between a read state and a continuous wave (CW) only state, each of the RFID readers having a respective read-zone; operating each of the plurality of RFID readers in a low duty cycle such that for a part of a cycle each of the plurality of RFID readers operates in the CW-only state and for another part of the cycle each of the plurality of RFID readers operates in read state; and instructing at least one of the plurality of RFID readers to operate in a full duty cycle such that the at least one of the plurality of RFID readers is operated in the read state for the entire cycle when a new RFID tag is detected within the respective read-zone of the at least one of the plurality of RFID readers.

In still yet another embodiment, the present invention is a method of maintaining radio frequency (RF) identification (RFID) tags in a respective state, the RFID tags being switchable between a first state and a second state, and the respective state being one of the first state and the second state. The method includes: providing a plurality of RFID readers spaced apart within a venue, each of the RFID readers being operably switchable between a read state and a continuous wave (CW) only state, each of the RFID readers having a respective read-zone; monitoring, via at least one detector, for a presence of at least one object of interest within the respective read-zone of at least one of the RFID readers; instructing, by a controller communicatively connected to the plurality of RFID readers and further to the at least one detector, each of the RFID readers having the at least one object of interest not detected in the respective read-zone for a first predetermined amount of time, to operate in the CW-only state; and instructing, by the controller, each of the RFID readers having the at least one object of interest detected in the respective read-zone, to operate in the read state.

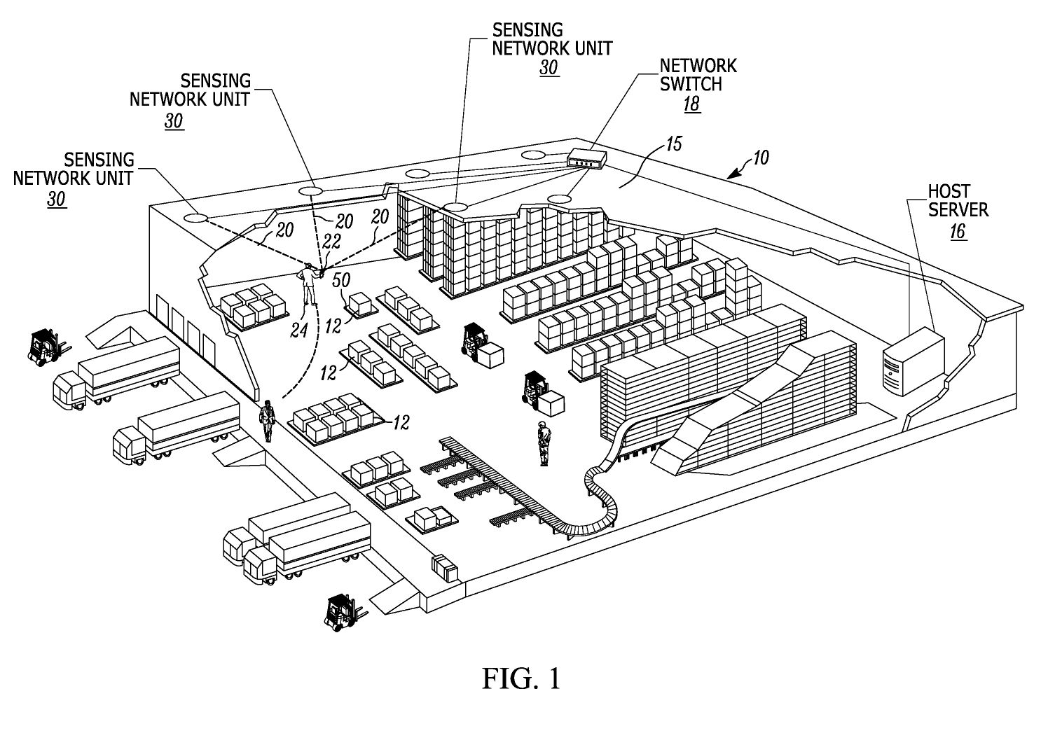

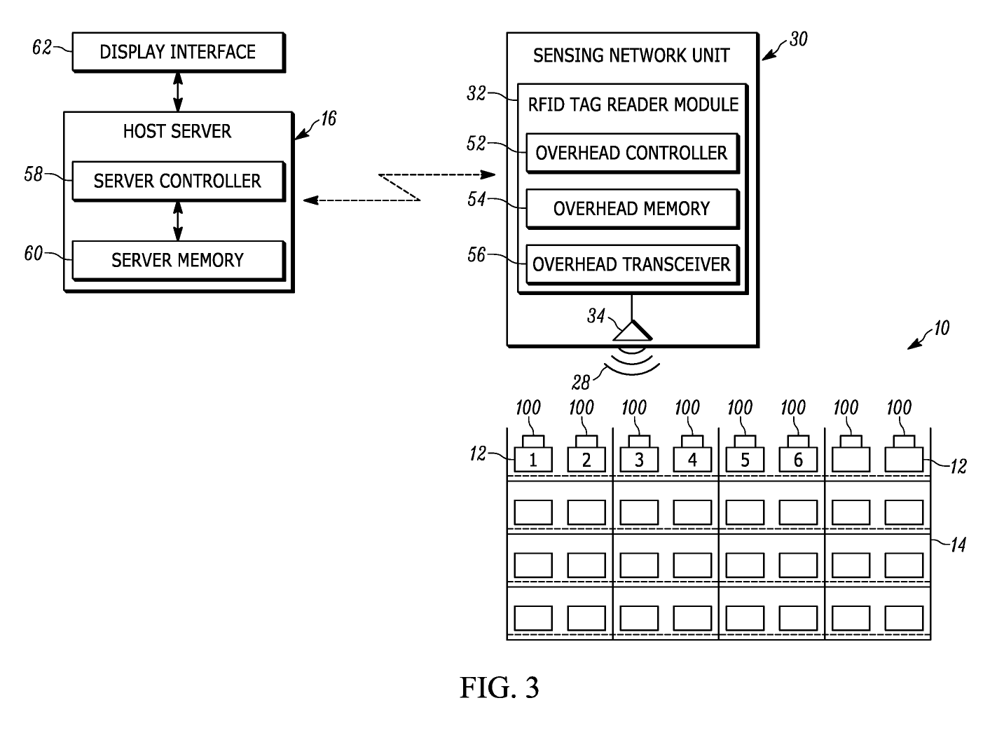

Referring now to the drawings, reference numeral 10 in FIG. 1 generally depicts a warehouse environment or venue in which products 12, shown in FIG. 1 as cuboid cartons for simplicity, are located. The venue 10 may be any indoor or outdoor venue (e.g., a retail store, warehouse, etc.), and may have any layout or configuration. As shown in FIG. 3, the venue 10 may have, for example, a plurality of shelving structures 14 separated by aisles, and a plurality of the products 12 can be stocked on the shelving structures. Each product 12 is preferably tagged with an RFID tag 100, preferably a passive RFID tag for cost reasons, and, in some applications, each RFID product tag 100 may be associated with a pallet 50 (see, e.g., FIG. 1), or a container, for supporting multiple products 12.

As also shown in FIG. 1, a plurality of sensing network units 30 is deployed in the venue 10. Sensing network units 30 are stationarily and fixedly mounted overhead, for example, on, or adjacent to, a ceiling 15. In some embodiments, the sensing network units 30 are installed every twenty to eighty feet or so in a grid pattern. A network computer or host server 16, typically locally located in a backroom at the venue 10, comprises one or more computers and is in wired, wireless, direct, or networked communication with each sensing network unit 30 through a network switch 18. The server 16 may also be remotely hosted in a cloud server. The server 16 may include a wireless RF transceiver that communicates with each sensing network unit 30. For example, Wireless Fidelity (Wi-Fi) and Bluetooth® are open wireless standards for exchanging data between electronic devices. The server 16 can control each sensing network unit 30. As shown in FIG. 3, the server 16 includes a controller 58 and a memory 60, and a connected display interface 62. It should be understood that references to a server 16 providing configuration in a certain way shall also apply to the controller 58 providing configuration in the same/similar manner.

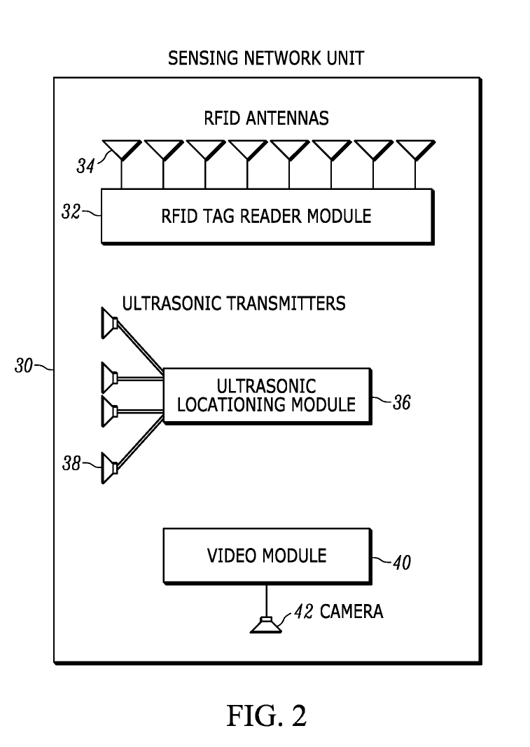

The block diagram of FIG. 2 depicts various sensing systems that can be mounted in each overhead sensing network unit 30. One of these sensing systems is an RFID tag reader operative for reading the tags 100 over a corresponding plurality of coverage ranges or read-zones. More particularly, each overhead RFID reader includes an RFID tag reader module 32 that has, as shown in FIG. 3, a controller 52, a memory 54, and an RF transceiver 56, which are operatively connected to a plurality of RFID antenna elements 34, which are energized by the RFID module 32 to radiate an RF beam 28 over an antenna field pattern. The RF transceiver 56 is operated, under the control of the controller 52 and/or the controller 58, to transmit RF beams 28 to the tags 100, and to receive RF response signals from, the tags 100, thereby interrogating and processing the payloads of the tags 100 that are in its read-zone. The payload or captured target data identifies the tags 100 and their associated products. As shown in FIG. 3, the server 16 controls the overhead RFID readers in the plurality of sensing network units 30 to read the tags 100 on the products 1-6 in a stationary reading mode of operation in accordance with a set of reading parameters, as described below.

Another of the sensing systems is an ultrasonic locationing system operative for locating an ultrasonic-capable mobile device by transmitting an ultrasonic signal to an ultrasonic receiver, e.g., a microphone, on the mobile device 22 along (see FIG. 1). A positive identification of a mobile device 22 may be associated with a presence of a person (user) 24. More particularly, the locationing system includes an ultrasonic locationing module 36 having control and processing electronics operatively connected to a plurality of ultrasonic transmitters, such as voice coil or piezoelectric speakers 38, for transmitting ultrasonic energy to the microphone on the mobile reader 22. The receipt of the ultrasonic energy at the microphone locates the mobile device 22. Each ultrasonic speaker 38 periodically transmits ultrasonic ranging signals, preferably in short bursts or ultrasonic pulses, which are received by the microphone on the mobile reader 22. The microphone determines when the ultrasonic ranging signals are received. The locationing module 36, under the control of the server 16, directs all the speakers 38 to emit the ultrasonic ranging signals such that the microphone on the mobile reader 22 will receive minimized overlapping ranging signals from the different speakers 38. The flight time difference between the transmit time that each ranging signal is transmitted and the receive time that each ranging signal is received, together with the known speed of each ranging signal, as well as the known and fixed locations and positions of the speakers 38 on each sensing unit 30, are all used to determine the position of the microphone and of the mobile device 22, using a suitable locationing technique, such as triangulation, trilateration, multilateration, etc, as diagrammatically shown by dashed lines 20 in FIG. 1.

Another sensing system that could be used to detect a presence of a person/an object of interest is a video system operative for locating the mobile reader 22 by capturing an image of a predefined field of view FOV. More particularly, the video system can be mounted in each sensing network unit 30 and includes a video module 40 having camera control and processing electronics that is connected to a camera 42 for capturing at least one image capture (e.g., one or multiple snapshots, or a video stream). In some embodiments, the camera 42 is configured to capture an image over a FOV every x number of time units (e.g., second). In some embodiments, the camera 42 is configured to capture a continuous video stream. In some embodiments, the camera 42 is configured to capture periodic video streams every y number of time units (e.g., second) with each stream lasting every z number of time units (e.g., second). With reference to these examples, the captured images/video streams may be referred to as video capture data. The camera 42 can be a high-bandwidth, moving picture expert group (MPEG) compression camera. In some implementations, the camera may have a wide-enough FOV to capture images/video over an area that is covered by more than one RDIF read-zone. In some implementations, the camera may have a FOV corresponding to a particular read-zone of a specific RFID reader. The video capture data is transmitted from the camera 42 to the server 16 for processing where image/video analysis can be employed to detect the presence of a person. In embodiments where a camera's FOV is associated with a read-zone of a particular RFID reader, the detection of a person in that camera's video capture data can signal a presence of a person in the read area of the particular RFID reader. In embodiments where a camera's FOV encompasses multiple RFID read-zones, different portions of the FOV can be associated with different RFID readers and their respective read-zones. In this case, a detection of a person in a particular portion of the FOV can signal a presence of a person in the read-zone of an RFID reader associated with the specific portion of the FOV.

Besides the sensing systems described above, other sensing system can also be used for the detection of objects of interest or the above-described systems can be used in a variety of ways. For instance, in some implementations the video system can be configured to detect movement, acting as a motion detector to detect movement in a designated area. This would be equivalent to detecting a presence of an object of interest when your object of interest is any object that exhibits movement. In other implementations, a dedicated motion detector can be used to deport detection of motion. As before, the indication of motion can be considered a detection of presence of an object of interest when the object of interest is any object that exhibits movement. In some configurations these systems can also be combined. For example, a triggering of a motion detector can signal the analysis of a video feed to determine if the object responsible for setting off the motion detector fits the characteristics of the object of interest. In this case, resources spent on video analysis are conserved as video analysis is not performed when no movement is detected.

When used in certain ways, the aforementioned sensing systems may be used to reduce RF signal collisions. In particular, it has been recognized that when people or other moving objects (e.g., robotic picker) are absent from an area which houses products 12, there is a relatively low need to constantly read all RFID tags in the corresponding area as those tags are likely to remain stationary. This changes when a person or a moving object enters an area as it then much more likely that at least some products will be picked and/or moved from their original location. At least some embodiments of the present disclosure take this into consideration, adjusting the parameters of RFID readers based on the detection of moving objects within the respective RFID reader read-zones.

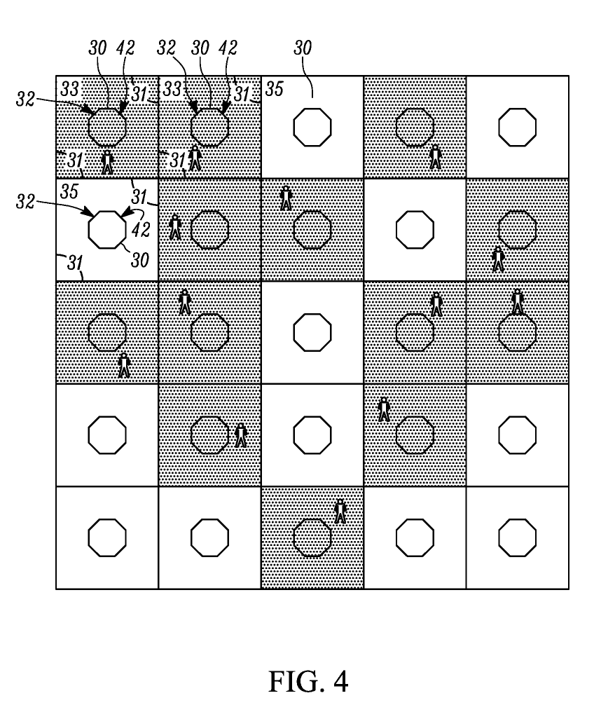

Referring to FIG. 4, shown therein in a top block view of an exemplary venue 10 having a plurality of sensing network units 30 disposed therethroughout. As disclosed previously, each sensing network unit 30 includes at least one RFID reader and a video camera. For the illustrated embodiment, with respect to each individual sensing network unit 30, the read-zone of the at least one RDIF reader and the FOV of the video capture data are bound by the respective boundaries 31 within which each sensing network unit 30 is shown. This allows video capture data from each of the cameras 42 to be used by the server 16 to monitor for a presence of an object, such as person, within the respective RFID reader read-zones. Once a presence of a person is detected, the server 16 instructs a respective RFID reader module 32 to operate in a read state where the RFID reader module broadcasts a modulated signal. Otherwise, if no objects, such as people, are detected by the camera 42 or a predetermined amount of time has passed since such an object was last detected, the server 16 instructs the respective RFID reader module 32 to operate in a CW-only state where the RFID reader module does not broadcast modulated signals, and instead emits an electromagnetic wave of constant amplitude and frequency.

In case of FIG. 4, this configuration would cause the respective RFID reader modules in zones 33 to operate in a read state and in zones 35 to operate in CW-only state. This can be particularly advantageous since while the RFID tags in both zones 33 and 35 would maintain their appropriate flags, only signals emitted by RFID readers in zones 33 would be susceptible to collision. As an example, RFID tags in zones 35 which have already been read will continue to be in that state without the RFID readers in those zones contributing to the RF collisions in the venue 10. In this configuration, the average reduction of collided energy is given by 20 Log(RFID Readers in CW mode/Total RFID readers). This can be especially desirable in environments where the RFID readers can operate on a rather limited number of distinct frequencies (e.g., four separate distinct frequencies).

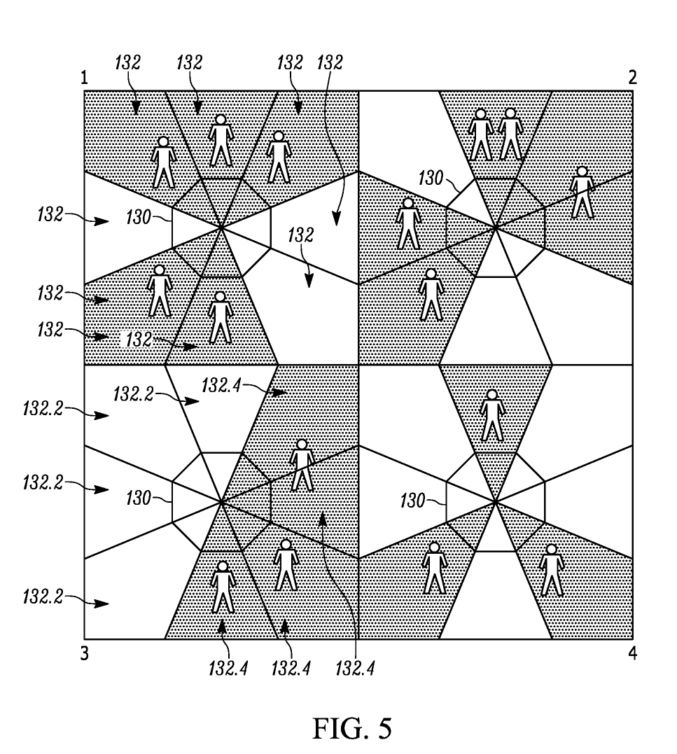

Another embodiment of a system in accordance with the present disclosure is illustrated in FIG. 5. Shown therein are four sensing network units 130 each having an RFID tag reader with eight directional antennas having respective RFID read-zones 132. Each sensing network unit 130 further includes a video camera with a field of view covering the respective sensing network unit's eight read-zones 132. In this embodiment, the video capture data obtained from any of the cameras is analyzed/monitored by the server 16 to determine a presence of an object of interest (e.g., a person) in a specific read-zone 132. Based on this analysis, the server 16 instructs the RFID reader to selectively function in a CW-only state for the specific read-zones 132 where no objects of interest are detected or where a predetermined amount of time has passed since any objects of interest was last detected. Otherwise, the server 16 instructs the RDIF reader module to selectively function in a read state for the specific read-zones 132 where objects of interest are detected. In this case, the selective functionality is accomplished by the directional antennas. As a result of this configuration, antennae covering the read-zones 132.2 of quadrant 3 operate in CW-only state and antennae covering the read-zones 132.4 of quadrant 3 operate in a read state.

In some embodiment, the server 16 is configured to wait a predetermined amount of time after an object of interest has not been detected before instructing the appropriate RFID reader to switch from a read state to a CW-only state.

Additionally, in some embodiments the RDIF readers can be configured to operate in a low duty cycle such that for a part of a cycle the RFID readers operate in a CW-only state and for another part of the cycle they operate in read state. In this configuration, the RFID readers can, in essence, monitor for new RFID tags, switching to operate at full duty cycle upon the detection of such a new tag.

In some embodiments, the RFID readers can also be instructed to switch from CW-only state to read state based on variables other than object detection. For example, an RFID reader may be instructed to switch from CW-only state to read state based on a passage of a predetermined amount of time. In another example, in a configuration similar to FIG. 5 where each RFID antenna of a respective sensing network unit may be activated sequentially, the RFID reader may be instructed to switch operating on a specific antenna from CW-only state to read state based on a number of consecutive times the specific antenna has been activated in CW-only state.

Additionally, in some embodiments, video/image based object detection can be supplemented with or replaced with other means of detecting objects within a predefined area. For example, ultrasonic locationing may be used to located a moving device that is capable of receiving ultrasonic signals. Such a movement may be associated with, for example, a person carrying the device on his person.

It should also be noted that while the embodiments above have been described with reference to sensing network units, skilled artisans will recognize that such units are not necessary for implementing the systems and methods described herein. Each of the electronic components can be housed in a separate housing and located separate from any other electronic component. Accordingly, as an example, the RFID reader(s) and video camera(s) may be housed and located separately from one another.

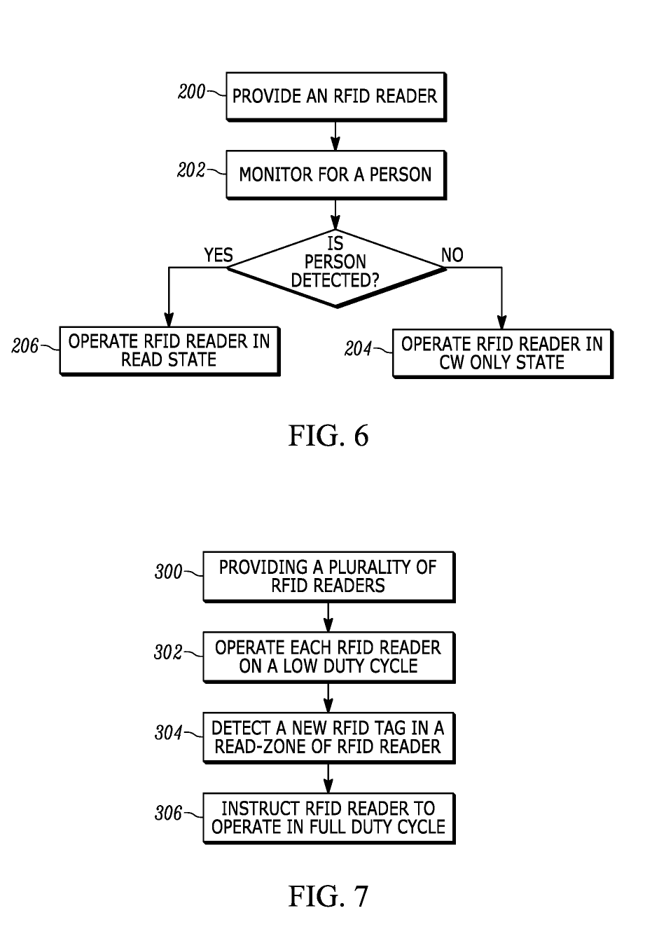

Referring now to FIG. 6, shown therein is a flowchart representative of a method in accordance with an embodiment of the present disclosure. The method is directed to operating an RFID reader. In step 200, the method includes the step of providing, within a venue, an RFID reader having a read-zone. The RFID reader is operably switchable between a read state and a CW-only state. In step 202, the method includes monitoring, via a detector, for a presence of a person within the read-zone of the RFID reader. If a person is not detected for a first predetermined amount of time, the RFID reader is instructed in step 204, by a controller communicatively connected to the RFID reader and further to the detector, to operate in the CW-only state. Otherwise, if a person is detected, the RDIF reader is instructed in step 206, by the controller, to operate in the read state. After completing the read operations in either steps 204/206 and a predetermined delay, the method returns to either step 200/202.

Another exemplary method in accordance with the present disclosure represented in the flowchart of FIG. 7. Represented therein is a method of maintaining RFID tags in a respective state, where the RFID tags are switchable between a first state and a second state, and where the respective state is one of the first state and the second state. In step 300, the method includes the step of providing a plurality of RFID readers, each of the RFID readers having a respective read-zone, spaced apart within a venue, each of the RFID readers being operably switchable between a read state and a CW-only state. In step 302, the method includes operating each of the plurality of RFID readers in a low duty cycle such that for a part of a cycle each of the plurality of RFID readers operates in the CW-only state and for another part of the cycle each of the plurality of RFID readers operates in read state. Finally, in step 304, the method includes detecting a new RFID tag within the respective read-zone of the at least one of the plurality of RFID readers and in step 306, instructing the RFID reader(s) within whose read-zone(s) the new tag was detected to operate in a full duty cycle such that the RFID reader(s) operate in the read state for the entire cycle. Afterwards, and after some predetermined delay, the method returns to step 302 to operate each RFID reader in a low duty cycle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system for reading radio frequency (RF) identification (RFID) tags via an interrogation signal, the system comprising:
a plurality of RFID readers spaced apart within a venue, each of the RFID readers being operably switchable between a read state and a continuous wave (CW) only state, each of the RFID readers having a respective read-zone;
at least one detector operable to detect a presence of at least one object of interest within the respective read-zone of at least one of the RFID readers; and
a controller communicatively connected to the plurality of RFID readers and further to the at least one detector, the controller operable to instruct each of the RFID readers to operate in the read state when the at least one object of interest is detected in the respective read-zone, the controller further operable to instruct each of the RFID readers to operate in the CW-only state when the at least one object of interest is not detected in the respective read-zone.

2. The system of claim 1, wherein the at least one detector includes at least one video camera.

3. The system of claim 1, wherein the read state includes a broadcast of a modulated signal.

4. The system of claim 3, wherein the CW-only state excludes the broadcast of the modulated signal.

5. The system of claim 1, wherein the at least one detector is a motion detection.

6. The system of claim 1, wherein the RFID tags are switchable between a first state and a second state,
and wherein the RFID tags located within the respective read-zones of each of the plurality of RFID readers operating in the CW state are maintained in their respective state by the each of the plurality of RFID readers operating in the CW state, the respective state being one of the first state or the second state.

7. A method of operating a radio frequency (RF) identification (RFID) reader, the method comprising:
providing, within a venue, an RFID reader having a read-zone, the RFID reader being operably switchable between a read state and a continuous wave (CW) only state;
monitoring, via a detector, for a presence of an object of interest within the read-zone of the RFID reader;
instructing, by a controller communicatively connected to the RFID reader and further to the detector, the RFID reader to operate in the CW-only state when the object of interest is not detected in the read-zone for a first predetermined amount of time; and
instructing, by the controller, the RFID reader to operate in the read state when the object of interest is detected in the read-zone.

8. The method of claim 7, wherein the detector includes a video camera.

9. The method of claim 7, wherein instructing the RFID reader to operate in the read state includes broadcasting a modulated signal.

10. The method of claim 9, wherein instructing the RFID reader to operate in the CW-only state excludes broadcasting the modulated signal.

11. The method of claim 7, further comprising:
instructing, by the controller, the RFID reader operating in the CW-only state to operate in the read state.

12. The method of claim 11, wherein a period between the instructing the RFID reader to operate in the CW-only state and instructing the RFID reader operating in the CW-only state to operate in the read state is based at least in part on at least one of a second predetermined amount of time or a predetermined number of RFID reader activations.

13. A method of maintaining radio frequency (RF) identification (RFID) tags in a respective state, the RFID tags being switchable between a first state and a second state, and the respective state being one of the first state and the second state, the method comprising:
providing a plurality of RFID readers spaced apart within a venue, each of the RFID readers being operably switchable between a read state and a continuous wave (CW) only state, each of the RFID readers having a respective read-zone;
operating each of the plurality of RFID readers in a low duty cycle such that for a part of a cycle each of the plurality of RFID readers operates in the CW-only state and for another part of the cycle each of the plurality of RFID readers operates in read state; and
instructing at least one of the plurality of RFID readers to operate in a full duty cycle such that the at least one of the plurality of RFID readers is operated in the read state for the entire cycle when a new RFID tag is detected within the respective read-zone of the at least one of the plurality of RFID readers.

14. The method of claim 13, further comprising:
instructing the at least one of the plurality of RFID readers to operate in the low duty cycle after no new RFID tags are read for a predetermined amount of time.

15. The method of claim 13, wherein during the low duty cycle, each of the plurality of RFID readers operates in the CW-only state for a greater portion of the cycle than in read state.

16. The method of claim 13, wherein during the low duty cycle, each of the plurality of RFID readers operates in the CW state for approximately 90% of the cycle and in read state for approximately 10% of the cycle.

17. The method of claim 13, wherein the read state includes a broadcast of a modulated signal.

18. The method of claim 17, wherein the CW-only state excludes the broadcast of the modulated signal.

19. The method of claim 17, wherein the modulated signal is broadcast at any one of four separate radio frequencies.

20. A method of maintaining radio frequency (RF) identification (RFID) tags in a respective state, the RFID tags being switchable between a first state and a second state, and the respective state being one of the first state and the second state, the method comprising:
providing a plurality of RFID readers spaced apart within a venue, each of the RFID readers being operably switchable between a read state and a continuous wave (CW) only state, each of the RFID readers having a respective read-zone;
monitoring, via at least one detector, for a presence of at least one object of interest within the respective read-zone of at least one of the RFID readers;
instructing, by a controller communicatively connected to the plurality of RFID readers and further to the at least one detector, each of the RFID readers having the at least one object of interest not detected in the respective read-zone for a first predetermined amount of time, to operate in the CW-only state; and
instructing, by the controller, each of the RFID readers having the at least one object of interest detected in the respective read-zone, to operate in the read state.
